(19) United States
(12) Patent Application Publication
(10) Pub. No.: US 2025/0242361 A1
(43) Pub. Date: Jul. 31, 2025

(54) Blower attachment and system for atomizing and dispensing liquids

(71) Applicant: Ryan Powal, Crystal Lake, IL (US)

(72) Inventor: Ryan Powal, Crystal Lake, IL (US)

(21) Appl. No.: 18/582,134

(22) Filed: Feb. 20, 2024

Related U.S. Application Data
(60) Provisional application No. 63/627,412, filed on Jan. 31, 2024.

(51) Int. Cl. B05B 7/24; B05B 1/16; B05B 12/00

(52) U.S. Cl. CPC B05B 7/2402; B05B 1/169; B05B 12/002

(57) ABSTRACT

The invention is a universal blower attachment that will fit any standard handheld leaf blower or standard backpack blower and a system for atomizing and dispensing insecticides and other liquids, with an adjustable turn valve to adjust liquid pressure, allowing a pressurized tank to continually force liquid through one or more adjustable nozzles for continuous atomization and spraying into the exhaust stream of the leaf blower.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The present invention is a universal blower attachment that will fit any standard handheld leaf blower or standard backpack blower and a system for atomizing and dispensing insecticides and other liquids, comprising one or more nozzles to optimize spraying efficiency.

### BACKGROUND OF THE INVENTION

Individuals and homeowners engaged in the maintenance of their yards and gardens commonly require personal spraying devices for the spraying of liquids such as insecticides, repellants, herbicides and fungicides. Such sprayers tend to be either hand bottles with atomizing nozzles wherein the user's own pumping action provides the spraying power, or pump-style pressurized containers wherein the user activates spraying by pulling a trigger opening a tube to a nozzle, and allowing the pent-up pressure to provide the spraying power.

Known commercial blowers and/or misters often cost from $600 to $1,000 retail, putting them outside the budget of most home users. Thus, home users are left either paying a professional for spraying services, or obtaining one of the personal spraying devices currently available on the market.

Such personal spraying devices suffer from a number of problems. In particular, the amount of power generated by hand pumping or pre-pumping into a pressurized container is quite limited. As such, the range of such a sprayer is similarly limited, often to a few feet when the nozzle is dilated to a stream and to a mere foot or two when the nozzle is set to atomize.

Further, in the case of a pre-pump spray container, the pressure quickly drops upon engagement and requires the user to stop after 30 seconds or less to pump again before spraying can continue.

What is needed is a device or system that will provide high-power and consistent spraying capability to home users. The device and system as described herein will address these issues by applying atomized liquid into the high-power air stream of a powered leaf blower.

### BRIEF DESCRIPTION OF THE INVENTION

In a preferred embodiment, a blower attachment comprising a hose attaching a tank containing liquid to a clip body with a proximal end and a distal end, wherein the proximal end of the clip body is attached to an exhaust end of a blower, the hose runs through the clip body via a collar, the hose ends in a hose hole attached to one or more nozzles, wherein each of the one or more nozzles comprises an atomizer and an adjustable threaded cap.

In another preferred embodiment, the blower attachment as described herein, wherein the adjustable threaded cap provides an adjustable spray pattern and amount of spray.

In another preferred embodiment, the blower attachment as described herein, further comprising a clamp slot and where the means of attachment between the blower attachment and blower is a clamp with a turn key adjustment feature.

In another preferred embodiment, the blower attachment as described herein, wherein the one or more nozzles is embodied as a multi-nozzle system comprising two or more nozzles attached to a central channel, which central channel attaches to the hose hole, each nozzle comprising an atomizer and an adjustable threaded cap.

In another preferred embodiment, the blower attachment as described herein, wherein the two or more nozzles are arranged to face in different directions to achieve an optimum spray coverage.

In another preferred embodiment, the blower attachment as described herein, wherein the number of nozzles is four, five or seven, with at least four nozzles located equidistant around a circumference and at least one nozzle facing directly away from the blower exhaust.

In another preferred embodiment, the blower attachment as described herein, further comprising a tank connector and a push connector/turn valve attached between the tank and hose, respectively, such push connector/turn valve allowing for fast tank changes and simple pressure control over the amount of liquid being sprayed.

In another preferred embodiment, the blower attachment as described herein, wherein the tank connector comprises a thread pattern for connection to a specific tank(s) and can be removed from the push connector/turn valve and replaced with another tank connector such that multiple types of tank can be utilized.

### BRIEF DESCRIPTION OF THE DRAWINGS

FIG. 1 is a line drawing evidencing the body of a blower attachment for atomizing liquids into the air stream of a leaf blower.

FIG. 2 is a line drawing evidencing the blower attachment of FIG. 1, together with a hose for delivering atomized liquid.

FIG. 3 is a line drawing evidencing the blower attachment of FIGS. 1 and 2, clamped over the exhaust pipe of a leaf blower.

FIG. 4 is a line drawing evidencing a nozzle assembly for attachment to the system of FIG. 4.

FIG. 5 is a line drawing evidencing an integrated multi-nozzle block for attachment to the system of FIG. 4.

FIG. 6 is a line drawing evidencing an alternate embodiment of the multi-nozzle block of FIG. 6.

FIG. 7 is a line drawing evidencing another alternate embodiment of the multi-nozzle block of FIG. 6.

FIG. 8 is a line drawing evidencing the multi-nozzle block of FIG. 7 connected to the blower attachment body of FIG. 1 over a blower exhaust.

FIG. 9 is a line drawing evidencing certain components for attaching the components of FIG. 8 to a liquid reservoir tank.

FIG. 10 is a line drawing evidencing a system comprising the blower attachment and components of the previous figures in use with a liquid reservoir tank and leaf blower.

### DETAILED DESCRIPTION OF THE INVENTION

The invention is a blower attachment and atomizing system that will allow use of any standard handheld or backpack leaf blower to spray pesticides, herbicides, fungicides or other liquids, thus providing greater reach and coverage than free-standing home sprayers currently on the market. The atomizing system comprises an atomizer, liquid tube, pressurized liquid container and a leaf blower.

The blower attachment will attach to a hose that also is attached to a standard pump spray tank. The user will be able to choose different size tank such as a 1 gallon or 2 gallon handheld tank, or backpack 3 to 4 gallon tank. The tanks will be pressurized by a manual or powered pump that will push the liquid through the hose, through the atomizer end of the hose, and will be atomized by the blower. The pressurization of the liquid will allow the user to spray in high and low areas. The blower force along with the atomization of the liquid will allow users to disrupt bushes, shrubs and tree leaves to allow application of the atomized liquid throughout the foliage, including under leaves, on stems and other locations where insects may be located.

With specific reference to the disclosed blower attachment, it is to be a universal attachment that will fit any standard handheld leaf blower or standard backpack blower and will be used to atomize and dispense insecticides and other liquids. A pressurized tank will allow the liquid to continually flow through the atomizer end, allowing users to spray high and low areas.

In a preferred embodiment, the blower attachment is adjustably clamped to the exhaust end of the blower with a clamp, pins, screws, or similar means of attachment. A hose for transmitting liquid to be atomized will be attached to each of the pressurized tank acting as a liquid reservoir, as well as to the blower attachment utilizing one or more hose clip components. Such hose clip component(s) will preferably be embodied as horseshoe-shaped plastic clips integrated with the body of the attachment, into which the flexible hose body may be stably and removably inserted. The end of the hose opposite the reservoir tank will comprise an atomizer, with a narrowed diameter to create increased pressure and expel the pumped liquid from the hose as an atomized spray. The body of the attachment will further comprise at least one hose hole into which the atomizer at the end of the hose may be inserted. A preferred design of the hose for such arrangement includes a bend of approximately 90% at the point where the atomizer is attached to the hose, allowing the atomizer to emanate outward at a roughly right angle from the hose for insertion into the hose hole.

In a preferred embodiment, the clip body of the blower attachment will be manufactured using injection molding or a similar type of plastic molding, using a plastic such as PET, PETE, polyester, polypropylene, HDPE, PVC or a similar material. The atomizer end of the hose will preferably be made similarly.

In a preferred embodiment, such hose hole(s) will be bored into a post emanating from the attachment clip body, placing the atomizer in a position roughly in the center of the blower exhaust pipe to which the attachment is clamped. Preferably, the clamp may be slotted and attached to a key tightener assembly for adjustment. The atomizer will fit into such hole facing away from the blower so that the atomized liquid particles eject in the same direction as the blower air flow, thus allowing the blower air flow to carry away and disperse the atomized liquid particles.

In a preferred embodiment, the system may include a fabric strap for strapping the hose to the body of the blower exhaust pipe to prevent slack in the hose from catching branches or tripping the user. Such fabric would preferably be a hook-and-loop self-attaching fabric.

In an alternate embodiment, the hose may comprise a diffuser at the end, such diffuser configured as a mesh or series of concentric circles to further break up and atomize the liquid upon ejection. In another alternate embodiment, the hose may further comprise an adjustment mechanism to regulate the flow of liquid through the hose or atomized fluid ejected from the hose. Such mechanism may take the form of a knob attached to a ball valve or other similar valve-based system. In a more preferred embodiment, the atomizer end itself comprises a turn dial for flow regulation.

In a preferred embodiment, the atomizer end of the hose is instead attached to or integrated with a commercially available nozzle, comprising a channel ending in multiple small emission holes to increase pressure and exit velocity of the dispersed liquid. Such nozzles are usually overlaid with a cap component with a center hole, usually removable and adjustable by a threaded connection to the nozzle body, such that tightening the cap brings it closer to the emission holes and thus strengthens and tightens the emitted liquid stream, whereas loosening the cap increases its distance from the emission holes and thus weakens and broadens the emitted liquid stream, thus creating a mist cloud of varying proportions.

In a more preferred embodiment, the single nozzle is replaced by a block of two or more nozzles, such block an integrated piece of plastic with a central channel. In this embodiment, the nozzles face in different or opposite directions to increase the area of mist disbursement. Such a block might incorporate, for example, four or six nozzles circumferentially, each emitting mist outward, as well as an optional forward-facing nozzle in the center emitting in the same direction as the blower exhaust.

A liquid atomizing and dispersal system, comprising clip body, blower, hose, nozzle block and reservoir tank, may be used for spraying any liquid useful in an outdoor setting, including but not limited to pesticides, herbicides, fertilizers, mold and mildew removers or detergents.

### DETAILED DESCRIPTION OF THE DRAWINGS

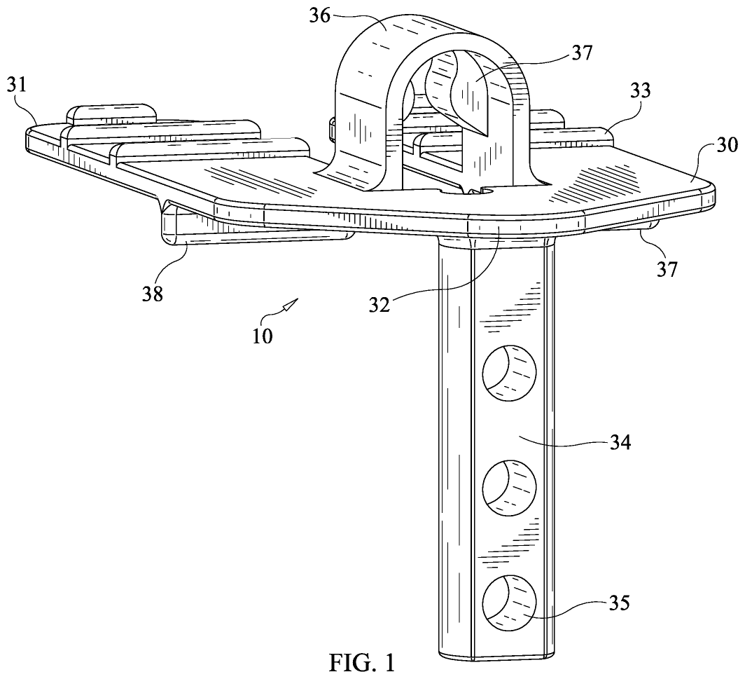

FIG. 1 is a drawing of the blower attachment 10 alone, comprising clip body 30 with proximal end 31 and distal end 32, with clamp slots 33 for securing the clamp (not pictured) in place over the exhaust pipe 61 (not pictured) of a blower and collar 36 comprising hose clip 37. Backstop 38 is an emanation from the clip body made to fit against the rim of such blower exhaust. Integral with the clip body 30 is hose post 34 emanating downward from near the distal end and comprising hose holes 35. When in use, the hose 70 (not pictured) will be clipped into hose clip 37, then continue downward for insertion into one of the hose holes 35. In a preferred embodiment, the side of the hose hole facing away from the blower will be larger than the side of the hose hole facing towards the blower, in order to accommodate the larger gate of interchangeable nozzles 72,74 (not pictured).

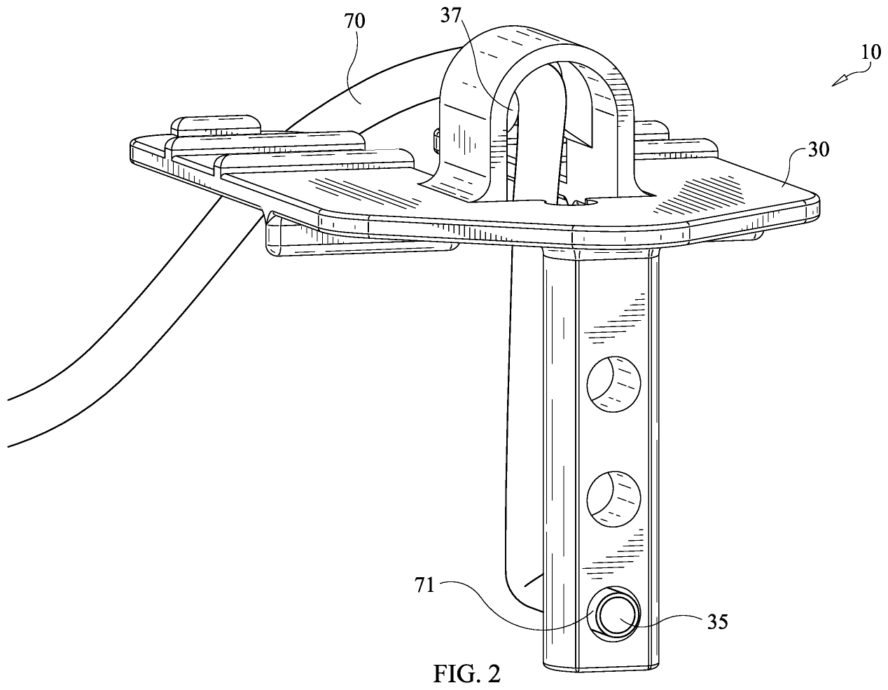

FIG. 2 shows the blower attachment 10 with hose 70 extending from tank 50, such hose clipped into hose clip 37, with the hose ending in atomizer end 71, such end centered within a hose hole 35.

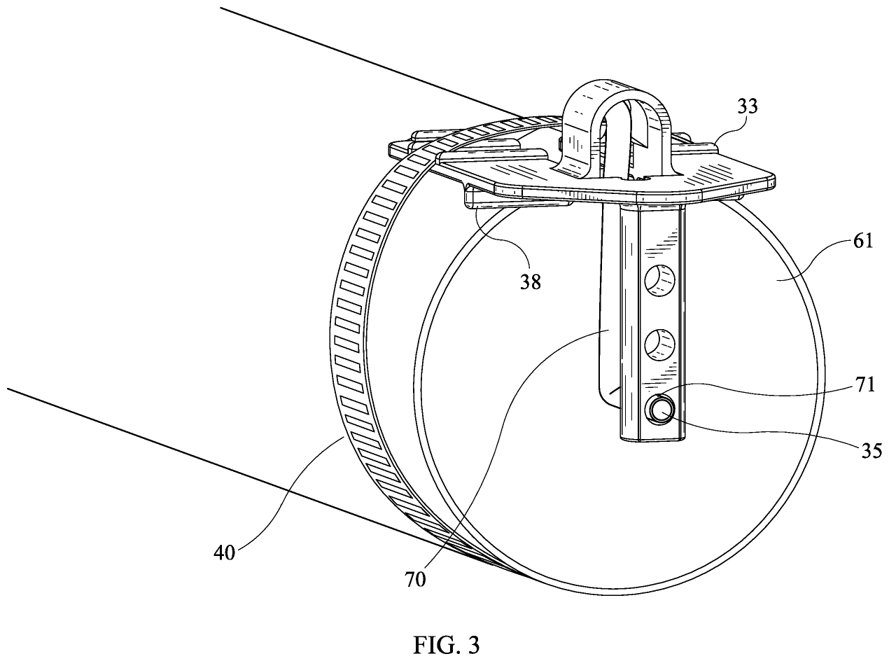

FIG. 3 shows blower attachment 10, with hose 70 clipped into hose clip 37 within collar 36, with clip body 30 clamped at its proximal end 31 onto blower exhaust pipe 61 by clamp 40, which clamp is arranged between clamp slots 33. In this way, atomizer end 71 of the hose is directed away from blower exhaust 61, so that as atomized liquid is expelled from hose 70, the atomized liquid is caught in and propelled by the air stream emanating from the blower exhaust 61.

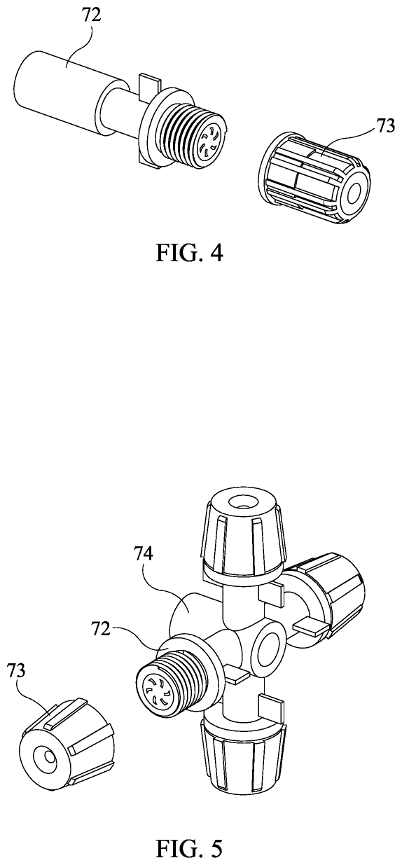

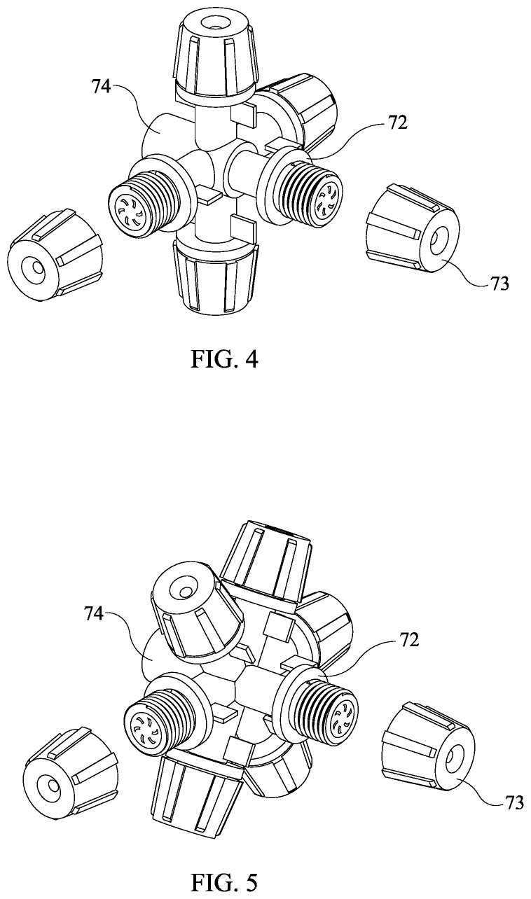

FIG. 4 shows an exemplary nozzle 72 acting as an atomizer for locating over the hose hole and producing a mist. The nozzle comprises a threaded, adjustable cap 73 which can be seated on or removed from the over the nozzle, and adjusted inward or outward using the threads to adjust the pressure and spread of the spray emanating from the nozzle.

FIG. 5 shows an exemplary nozzle system 74, comprising a central channel for connection to the hose hole (not pictured), thus connecting four separate nozzles 72, with each such nozzle located circumferentially at approximately a 90 degree angle to the nozzles next to it. Each nozzle also comprises an adjustable threaded cap 73 which can be seated on or removed from the over the nozzle, and adjusted inward or outward using the threads to adjust the pressure and spread of the spray emanating from the nozzle.

Preferred nozzle designs may comprise different specifications and generate different spray patterns and amounts of dispersed liquid, as further detailed below. By spraying atomized mist in multiple directions at once over the blower exhaust, a greater efficiency of spray coverage is achieved.

In another preferred embodiment, the mist nozzles will be interchangeable so that a user can create various narrow or wide spray patterns and vary the amount of liquid being dispensed.

FIG. 6 shows an alternative nozzle system 74 comprising five nozzles 72, wherein the fifth nozzle is forward-facing, and each nozzle comprises an adjustable threaded cap 73.

FIG. 7 shows an alternative nozzle system 74 comprising seven nozzles 72, each with an adjustable threaded cap 73, with six nozzles emanating from the center circumferentially and the seventh arranged to be forward-facing.

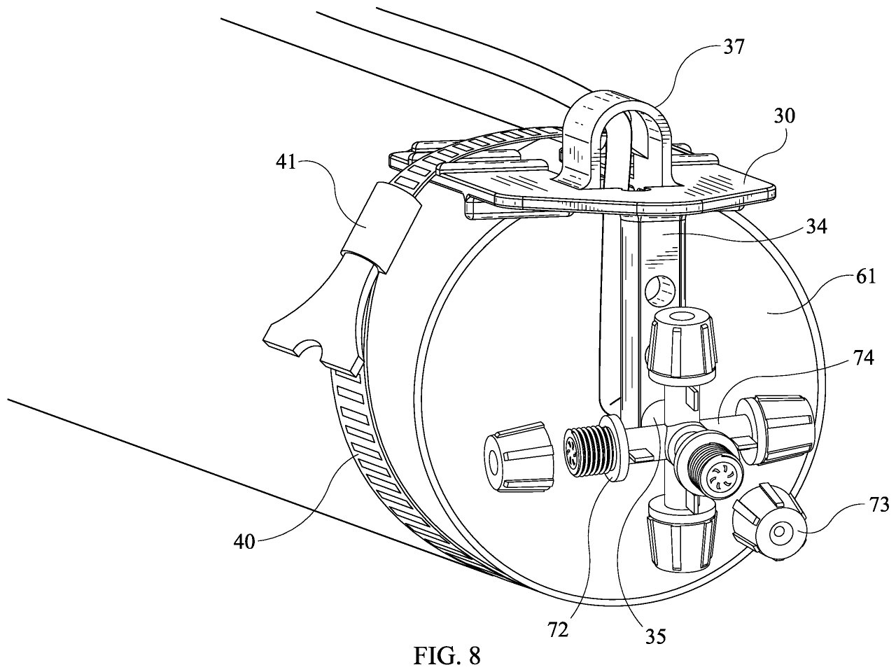

FIG. 8 shows the nozzle system 74 of FIG. 7 with five nozzles 72 and caps 73, such system inserted into the hose hole 35 of hose post 34 of the blower attachment of FIG. 1. The blower attachment is clamped to the blower exhaust pipe 61 with clamp 40, which is adjustable using the key 41 mechanism, which can be turned for tightening and loosening.

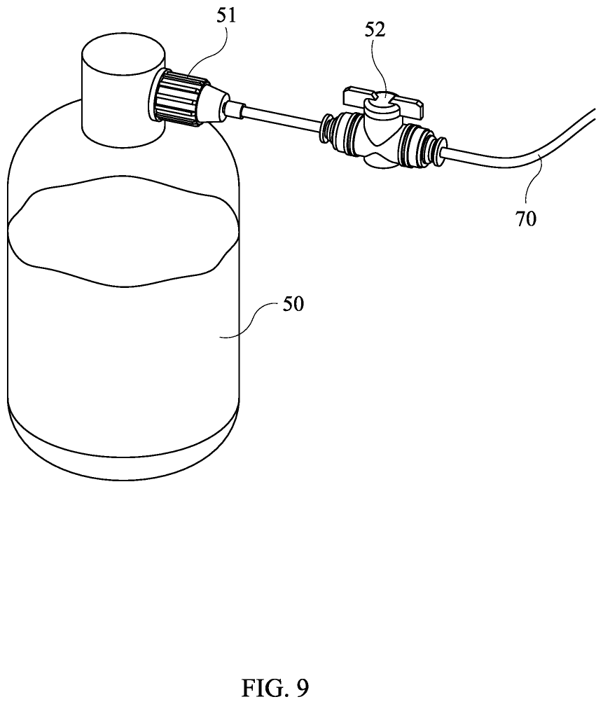

FIG. 9 shows a liquid tank 50 attached to a tank connector 51, such tank connector attached to a first side of the push connector/turn valve 52, which can be used to open, close and adjust the flow level of liquid flowing from the tank. A second side of the push connector/turn valve is connected to the hose 70, which transports the fluid downstream through the system (not pictured).

Preferred tank connector 51 designs will vary, with multiple connectors made available to a user in the system package, such that each user will find a connector appropriate for attachment to any commercially available tank that will easily plug in and unplug, thus allowing a user to employ various tanks for spraying. Importantly, the push connector/turn valve 52 and hose 70 can remain attached to the spraying system while being moved from one tank connector and tank to another. The tank connectors 51 will incorporate one or more of the following thread patterns:
System #1 Nut (MSS13): BSP Thread, 14.4 mm (0.56″)
System #2 Nut (MSS17): NPT Thread, 18 mm (0.70″)
System #3 Nut (MSS21): BSP Thread, ¾″
System #4 Nut (MSS23): Non-standard thread, in between NPT and BSP, 16.9 mm (0.66″)
System #5 Nut (MSS25): Non-standard thread, in between NPT and BSP, 17.5 mm (0.68″)
System #6 Nut (MSS32): NPT Thread, 24.6 mm (0.96″)
System #7 Nut (MSS33): Non-standard thread, in between NPT and BSP, 14.17 mm (0.55″)

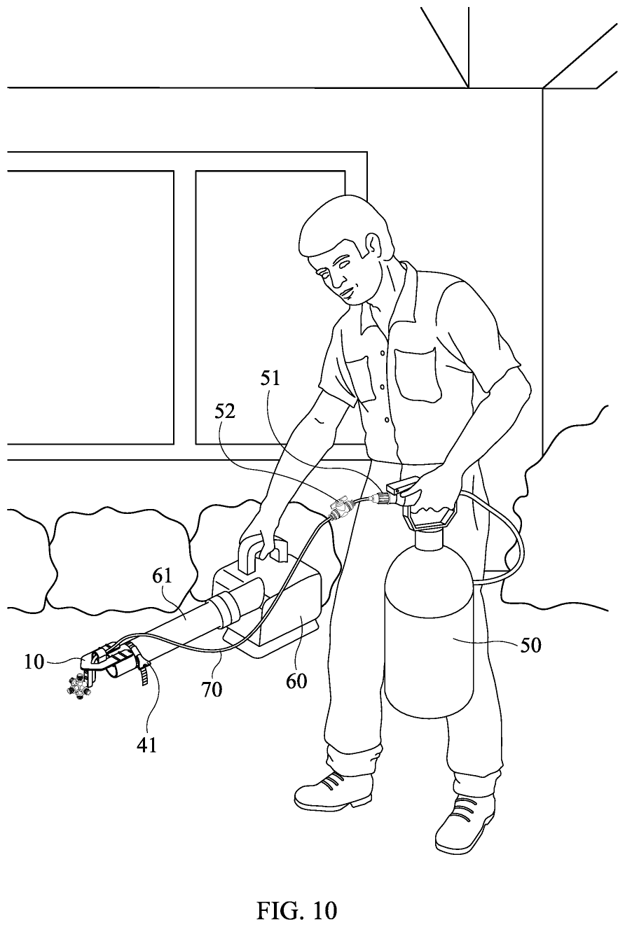

FIG. 10 is an illustration of an entire liquid atomizing and dispersal system comprising a blower attachment 10 and multi-nozzle system 74, clamped to a blower 60 at the blower exhaust pipe 61. A hose 70 is clipped into the blower attachment and extends to a pressurized tank 50 containing liquid to be atomized and spread, such tank held by the user. Between the tank and the hose are the bank connector 51 and push connector/turn valve 52. In other embodiments, either the blower, the tank or both could be embodied as a backpack, with a wheeled pull cart, or in other known styles for ease of use

### INVENTION COMPONENTS

10 Blower attachment
30 Clip body
31 Body proximal end
32 Body distal end
33 Clamp slots
34 Hose post
35 Hose hole
36 Collar
37 Hose clip
38 Backstop
40 Clamp
41 Key
50 Tank
51 Tank Connector
52 Push connector/turn valve
60 Blower
61 Blower exhaust pipe
70 Hose
71 Atomizer end
72 Nozzle
73 Nozzle Cap
74 Multi-nozzle system

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A blower attachment comprising a hose attaching a tank containing liquid to a clip body with a proximal end and a distal end, wherein the proximal end of the clip body is attached to an exhaust end of a blower, the hose runs through the clip body via a collar, the hose ends in a hose hole attached to one or more nozzles, wherein each of the one or more nozzles comprises an atomizer and an adjustable threaded cap.

2. The blower attachment of claim 1, wherein the adjustable threaded cap provides an adjustable spray pattern and amount of spray.

3. The blower attachment of claim 1, further comprising a clamp slot and where the means of attachment between the blower attachment and blower is a clamp with a turn key adjustment feature.

4. The blower attachment of claim 1, wherein the one or more nozzles is embodied as a multi-nozzle system comprising two or more nozzles attached to a central channel, which central channel attaches to the hose hole, each nozzle comprising an atomizer and an adjustable threaded cap.

5. The blower attachment of claim 4, wherein the two or more nozzles are arranged to face in different directions to achieve an optimum spray coverage.

6. The blower attachment of claim 3, wherein the number of nozzles is four, five or seven, with at least four nozzles located equidistant around a circumference and at least one nozzle facing directly away from the blower exhaust.

7. The blower attachment of claim 1, further comprising a tank connector and a push connector/turn valve attached between the tank and hose, respectively, such push connector/turn valve allowing for fast tank changes and simple pressure control over the amount of liquid being sprayed.

8. The blower attachment of claim 7, wherein the tank connector comprises a thread pattern for connection to a specific tank(s) and can be removed from the push connector/turn valve and replaced with another tank connector such that multiple types of tank can be utilized.
